(19) United States
(12) Patent Application Publication
(10) Pub. No.: US 2012/0153170 A1
(43) Pub. Date: Jun. 21, 2012

(54) RADIOGRAPHIC IMAGING DEVICE

(75) Inventor: Fumito NARIYUKI, Kanagawa (JP)

(73) Assignee: FUJIFILM CORPORATION, Tokyo (JP)

(21) Appl. No.: 13/325,058

(22) Filed: Dec. 14, 2011

(30) Foreign Application Priority Data
Dec. 16, 2010 (JP) 2010-280869
Dec. 1, 2011 (JP) 2011-264053

(51) Int. Cl. G01T 1/20

(52) U.S. Cl. 250/368; 250/361 R

(57) ABSTRACT

There is provided a radiographic imaging device including: a converting layer that is flat-plate-shaped and that converts irradiated radiation into light; a light detecting substrate that is disposed at one surface side of the converting layer, and detects light converted by the converting layer; an illuminating section that illuminates light with respect to another surface side of the converting layer; and a half-mirror that is provided over an entire surface of a region, which is between the converting layer and the light illuminating section and which corresponds to a detection region at which light is detected by the light detecting substrate, the half-mirror reflecting at least a portion of light converted by the converting layer, and transmitting at least a portion of light illuminated by the light illuminating section.

### CROSS-REFERENCE TO RELATED APPLICATION

This application is based on and claims priority under 35 USC 119 from Japanese Patent Applications No. 2010-280869 filed on Dec. 16, 2010 and No. 2011-264053 filed on Dec. 1, 2011, the disclosures of which are incorporated by reference herein.

### BACKGROUND

1. Technical Field

The present invention relates to a radiographic imaging device, and in particular, relates to a radiographic imaging device that carries out capturing of a radiographic image expressed by radiation that is emitted from a radiation source and passes through a subject.

2. Related Art

Radiation detectors such as FPDs (Flat Panel Detectors), in which a radiation-sensitive layer is disposed on a TFT (Thin Film Transistor) active matrix substrate and that can convert radiation such as X-rays or the like directly into digital data, and the like have been put into practice in recent years. A radiographic imaging device, that captures radiographic images expressed by irradiated radiation, is put into practice by using this radiation detector. As compared with a radiographic imaging device that uses conventional X-ray films or imaging plates, a radiographic imaging device using this radiation detector has the advantages that an image can be confirmed immediately, and through-imaging (video imaging), that carries out capturing of radiographic images continuously, can also be carried out.

Various types of such radiation detectors have been proposed. For example, there are: an indirect-conversion-type radiation detector in which a TFT active matrix substrate, at which sensor portions such as photodiodes or the like are formed, and a scintillator of CsI:Tl, GOS (Gd₂O₂S:Tb) or the like, are layered, and radiation is converted into light at the scintillator, and the converted light is converted into charges at the sensor portions of the TFT active matrix substrate, and the charges are accumulated; and the like. At the radiographic imaging device, the charges accumulated in the radiation detector are read-out as electric signals, and, after the read-out electric signals are amplified at an amplifier, the amplified signals are converted into digital data at an A/D (analog/digital) converting section.

In the indirect-conversion-type radiation detector, a semiconductor such as a-Si (amorphous silicon) or the like is generally used as the sensor portions such as the photodiodes or the like. However, there are cases in which charges become trapped once in the impurity levels of the semiconductors, and residual images arise due to the trapped charges being released.

Thus, Japanese Patent Application National Publication No. 2010-525359 proposes a technique in which a reflecting layer is provided at the surface of a scintillator, which surface is at the side opposite a TFT active matrix substrate, and the light that is generated at the scintillator is reflected at the reflecting layer. Numerous holes are formed in the reflecting layer. Due to light being illuminated onto the surface of the scintillator at which surface the reflecting layer is provided, the impurity potentials of the respective sensor portions of the TFT active matrix substrate are, before imaging, filled-in via the numerous holes of the reflecting layer and the scintillator. Due thereto, residual images can be erased while the efficiency of utilizing the light generated at the scintillator is improved.

However, in the technique of Japanese Patent Application National Publication No. 2010-525359, a process that forms the holes in the reflecting layer is needed, and the manufacturing processes become complex.

### SUMMARY

The present invention was made in view of the above-described circumstances, and an object thereof is to provide a radiographic imaging device that, without carrying out the complex manufacturing process of forming holes in a reflecting layer, can erase residual images while improving the efficiency of utilizing light generated at a scintillator.

In order to achieve the above-described object, the first aspect of the present invention provides a radiographic imaging device including:

a converting layer that is flat-plate-shaped and that converts irradiated radiation into light;

a light detecting substrate that is disposed at one surface side of the converting layer, and detects light converted by the converting layer;

an illuminating section that illuminates light with respect to another surface side of the converting layer; and

a half-mirror that is provided over an entire surface of a region, which is between the converting layer and the light illuminating section and which corresponds to a detection region at which light is detected by the light detecting substrate, the half-mirror reflecting at least a portion of light converted by the converting layer, and transmitting at least a portion of light illuminated by the light illuminating section.

In accordance with the first aspect of the present invention, the light detecting substrate, that detects light converted by the converting layer, is disposed at one surface side of the converting layer that is flat-plate-shaped and that converts irradiated radiation into light. Light is illuminated by the illuminating section onto the other surface of the converting layer.

The half-mirror, that reflects at least a portion of light converted by the converting layer and transmits at least a portion of light illuminated by the light illuminating section, is provided over the entire surface of a region that is between the converting layer and the light illuminating section and that corresponds to a detection region at which light is detected by the light detecting substrate.

In this way, in accordance with the first aspect of the present invention, the half-mirror, which reflects at least a portion of light converted by the converting layer and transmits at least a portion of light illuminated by the light illuminating section, is provided between the converting layer and the light illuminating section. Therefore, residual images can be erased while the efficiency of utilizing light generated at a scintillator (converting layer) is improved, without carrying out the complex manufacturing process of forming holes in a reflecting layer.

Here, the above expression of “the half-mirror reflects at least a portion of light converted by the converting layer” is intended to express a situation such that the reflectance of light converted by the converting layer and is incident to the half-mirror by an incidence angle 0° is 10% at a peak wavelength.

Further, the above expression of “the half-mirror transmits at least a portion of light illuminated by the light illuminating section” is intended to express a situation such that the transmittance of light illuminated by the light illuminating section and is incident to the half-mirror by an incidence angle 0° is greater than or equal to 10% at a peak wavelength.

It is more preferable that the reflectance of light converted by the converting layer and the transmittance of light illuminated by the light illuminating section is greater. It is more preferable that they are greater than or equal to 50%, and it is rather preferable that they are greater than or equal to 70%.

The second aspect of the present invention provides the radiographic imaging device of the first aspect, wherein

the converting layer is formed by a non columnar-crystal region and a columnar crystal region, that is continuous with the non columnar-crystal region, being layered, and the converting layer is provided such that the columnar crystal region faces the light detecting substrate.

The third aspect of the present invention provides the radiographic imaging device of the first aspect, wherein

the light detecting substrate is attached to a surface, at an opposite side of a surface on which radiation that has been transmitted through an object of imaging is incident, of a top plate portion of a housing at which the top plate portion is provided an image-capturing surface on which the radiation is irradiated.

The fourth aspect of the present invention provides the radiographic imaging device of the first aspect, wherein

light that is converted by the converting layer and light that is illuminated from the light illuminating section have different wavelength regions, and

a film thickness of the half-mirror is set such that reflectance of light of a second wavelength region that is converted by the converting layer, is higher than transmittance of light of a first wavelength region that is illuminated from the light illuminating section.

The fifth aspect of the present invention provides the radiographic imaging device of the first aspect, wherein

an air layer is provided between the converting layer and the illuminating section.

The sixth aspect of the present invention provides the radiographic imaging device of the first aspect, wherein the illuminating section comprises:

a light source; and

a light guide plate that is disposed so as to face the other surface side of the converting layer, and that guides light, that is generated at the light source, toward the light detecting substrate.

The seventh aspect of the present invention provides the radiographic imaging device of the sixth aspect, wherein

the converting layer is formed on a light-transmissive substrate that is light-transmissive, and a structure comprising the converting layer and the light-transmissive substrate is affixed to the light detecting substrate such that the converting layer faces the light detecting substrate, and

the light-transmissive substrate functions as the light guide plate.

The eighth aspect of the present invention provides the radiographic imaging device of the first aspect, wherein

the illuminating section is a light-emitting panel that is disposed so as to face the other surface side of the converting layer and at which a light-emitting section is provided in correspondence with the converting layer.

In accordance with the present invention, there is the effect that residual images can be erased while the efficiency of utilizing light generated at a scintillator is improved, without carrying out the complex manufacturing process of forming holes in a reflecting layer.

### BRIEF DESCRIPTION OF THE DRAWINGS

Exemplary embodiments of the present invention will be described in detail based on the following figures, wherein:

FIG. 1 is a transparent perspective view showing the internal structure of an electronic cassette relating to exemplary embodiments;

FIG. 2 is a sectional view schematically showing the structures of a radiation detector and a radiation detecting section relating to the exemplary embodiments;

FIG. 3 is a sectional view showing the structures of a thin film transistor and a capacitor of the radiation detector relating to the exemplary embodiments;

FIG. 4 is a plan view showing the structure of a TFT substrate relating to the exemplary embodiments;

FIG. 5 is a side view schematically showing the structure of the interior of an electronic cassette relating to a first exemplary embodiment;

FIG. 6 is a side sectional view for explaining an obverse reading method and a reverse reading method of radiation on the radiation detector;

FIG. 7 is a block diagram showing the structure of main portions of the electrical system of the electronic cassette relating to the exemplary embodiments;

FIG. 8 is a schematic drawing showing the placement of the electronic cassette at the time of radiographic image capturing;

FIG. 9 is a side view schematically showing the structure of the interior of an electronic cassette relating to a second exemplary embodiment;

FIG. 10 is a side view schematically showing the structure of the interior of an electronic cassette relating to a third exemplary embodiment;

FIG. 11 is a side view schematically showing the structure of the interior of an electronic cassette relating to another form;

FIG. 12 is a side view schematically showing the structure of the interior of an electronic cassette relating to yet another form;

FIG. 13 is a graph showing the distribution of the emission wavelengths of CsI(Tl) and examples of ranges of wavelength regions A, B;

FIG. 14 is an enlarged schematic drawing in which columnar crystals and sensor portions of the radiation detector are enlarged;

FIG. 15 is a sectional view showing transmission paths of green light and red light when green light and red light are both reflected at a half-mirror layer;

FIG. 16 is a sectional view showing transmission paths of green light and red light when green light is reflected at the half-mirror layer and red light is transmitted through the half-mirror layer;

FIG. 17 is a graph showing the distribution of the emission wavelengths of CsI(Tl) and examples of ranges of wavelength regions C, D, E; and

FIG. 18 is a graph showing an example of spectral transmittance with a cold mirror.

### DETAILED DESCRIPTION

Hereinafter, embodiments for implementing the present invention will be described in detail with reference to the drawings. Note that, here, description is given of an example of a case in which the present invention is applied to a portable radiographic imaging device (hereinafter also called “electronic cassette”).

### First Exemplary Embodiment

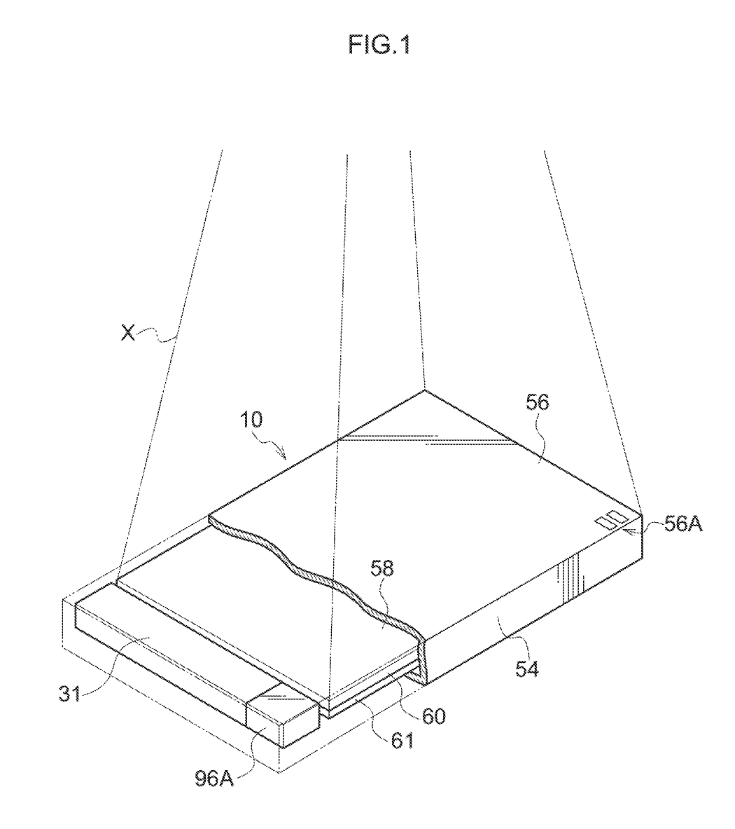

The structure of an electronic cassette 10 relating to the present exemplary embodiment is shown in FIG. 1.

As shown in FIG. 1, the electronic cassette 10 has a housing 54 formed from a material through which radiation X is transmitted, and is a structure that is waterproof and airtight. When the electronic cassette 10 is being used in an operating room or the like, there is the concern that blood or other various germs will stick thereto. Thus, by making the electronic cassette 10 be a waterproof and airtight structure and disinfectingly cleaning it as needed, the one electronic cassette 10 can be used repeatedly in continuation.

A radiation detector 60, which captures a radiographic image formed by radiation X that has passed through a subject, and a light guide plate 61, which is for guiding, to the radiation detector 60, light for erasing residual images of the radiation detector 60, are disposed within a housing 54 in that order from an irradiated surface 56 side of the housing 54 on which the radiation X that has passed through the subject is irradiated at the time of imaging.

A case 31, which accommodates electronic circuits including a microcomputer and accommodates a battery 96A that is chargeable and removable, is disposed at one end side of the interior of the housing 54. The radiation detector 60 and the electronic circuits are operated by electric power that is supplied from the battery 96A disposed in the case 31. In order to avoid damage that accompanies with irradiation of the radiation X to the various types of circuits, which are accommodated within the case 31, it is desirable to place a lead plate or the like at the image-capturing surface 56 side of the case 31. Note that the electronic cassette 10 relating to the present exemplary embodiment is a parallelepiped at which the shape of the image-capturing surface 56 is rectangular, and the case 31 is disposed at one end portion in the longitudinal direction thereof.

A display portion 56A, which carries out display showing the operating state of the electronic cassette 10 such the operating mode that is a “ready state” or “currently transmitting data”, and the state of the remaining capacity of the battery 96A, and the like, is provided at a predetermined position of an outer wall of the housing 54. Note that, although light-emitting diodes are used as the display portion 56A at the electronic cassette 10 relating to the present exemplary embodiment, the display portion 56A is not limited to the same, and may be light-emitting elements other than light-emitting diodes, or may be another display portion such as a liquid crystal display, an organic EL (electroluminescent) display, or the like.

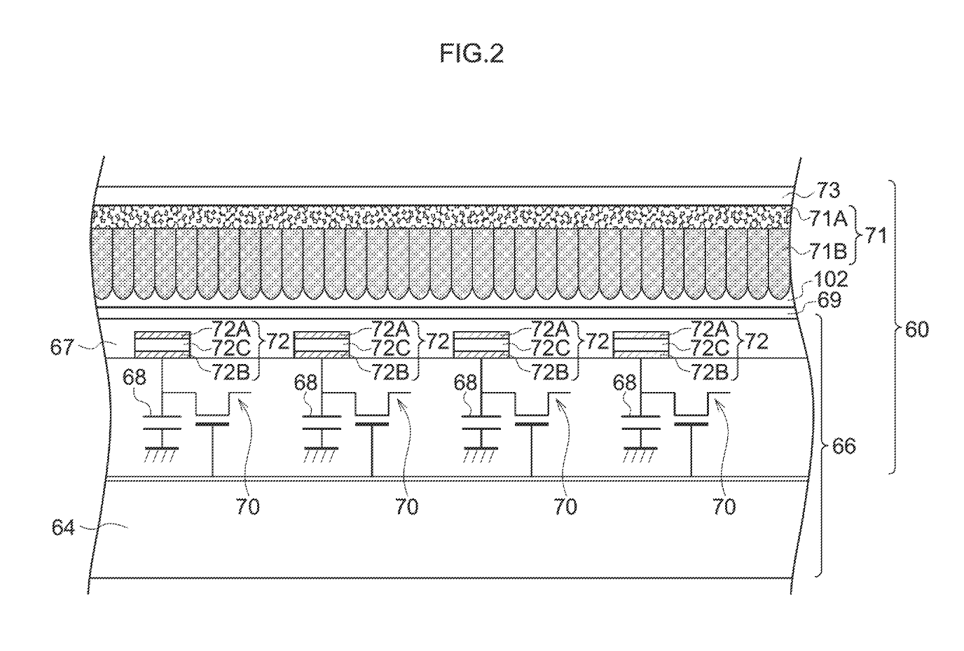

A sectional view schematically showing the structure of the radiation detector 60 relating to the present exemplary embodiment is shown in FIG. 2.

The radiation detector 60 has a TFT active matrix substrate (hereinafter called “TFT substrate”) 66 at which thin film transistors (hereinafter called “TFTs”) 70 and storage capacitors 68 are formed at an insulating substrate 64.

A scintillator 71, which converts incident radiation into light, is disposed on the TFT substrate 66.

For example, CsI:Tl or GOS (Gd₂O₂S:Tb) can be used as the scintillator 71. Note that the scintillator 71 is not limited to these materials. The wavelength region of the light that the scintillator 71 generates is preferably the visible light region (wavelengths of 360 nm to 830 nm). It is more preferable that the wavelength region of green color be included in order to enable monochromatic imaging by the radiation detector 60.

It should be noted that in the embodiment, the “wavelength region” means a region of wavelength within a FWHM (Full Width at Half Maximum) of intensity at a peak wavelength. It is preferable that the wavelength region of light emitted by the light source 95 (first wavelength region) is from 700 nm to 1200 nm. Further, it is more preferable that the first wavelength region is from 900 nm to 1000 nm. In a case in which CsI:Tl or GOS (Gd₂O₂S:Tb) is used as the scintillator 71, it is preferable that the wavelength region (second wavelength region) is from 400 nm to 700 nm.

Here, in the present exemplary embodiment, the scintillator 71 is made to be columnar crystals of, for example, CsI:Tl or the like. The scintillator 71 is formed by a material such as CsI:Tl or the like being vapor-deposited on a vapor deposition substrate 73. A non columnar-crystal region 71A is formed at the vapor deposition substrate 73 side of the scintillator 71, and a columnar crystal region 71B, that is formed from columnar crystals, is formed at the distal end side (the TFT substrate 66 side). A sealing portion 102, that seals the non columnar-crystal region 71A and the columnar crystal region 71B, is formed at the scintillator 71.

A material having a barrier ability with respect to moisture in the atmosphere is used as the sealing portion 102. An organic film obtained by vapor phase polymerization such as thermal CVD, plasma CVD or the like, is used as the material. A vapor phase polymer film that is formed by thermal CVD of a polyparaxylylene resin, or a plasma polymer film of a plasma polymer film unsaturated hydrocarbon monomer of a fluorine-containing compound unsaturated hydrocarbon monomer, is used as the organic film. Further, a layered structure of an organic film and an inorganic film can also be used. For example, a silicon nitride (SiNx) film, a silicon oxide (SiOx) film, a silicon oxynitride (SiOxNy) film, Al₂O₃, and the like are suitable as the inorganic film.

The scintillator 71 is disposed such that the columnar crystal region 71B side thereof faces the TFT substrate 66, and is adhered to the TFT substrate 66.

The insulating substrate 64 may be any substrate provided that there is little absorption of radiation thereat, and, for example, a glass substrate, a transparent ceramic substrate, or a light-transmissive resin substrate can be used. Note that the insulating substrate 64 is not limited to these materials.

Sensor portions 72, which generate charges due to light converted by the scintillator 71 being incident thereon, are formed at the TFT substrate 66. At the TFT substrate 66 relating to the present exemplary embodiment, the TFTs 70 and the sensor portions 72 are formed in separate layers so as to overlap. Due thereto, the light-receiving surface area of the sensor portion 72, at which light from the scintillator 71 is received, can be made to be larger. Further, a smoothing layer 67 for smoothing the top side of the TFT substrate 66 is formed at the TFT substrate 66. An adhesive layer 69 for adhering the scintillator 71 to the TFT substrate 66 is formed on the smoothing layer 67, between the TFT substrate 66 and the scintillator 71.

The sensor portion 72 has an upper electrode 72A, a lower electrode 72B, and a photoelectric converting film 72C that is disposed between the upper and lower electrodes.

The upper electrode 72A and the lower electrode 72B are formed by using a material having high light transmittance, such as ITO (indium tin oxide) or IZO (indium zinc oxide) or the like, and are light-transmissive.

The photoelectric converting film 72C absorbs light emitted from the scintillator 71, and generates charges that correspond to the absorbed light. It suffices for the photoelectric converting film 72C to be formed from a material that generates charges due to light being illuminated thereon, and, for example, can be formed from amorphous silicon or an organic photoelectric converting material or the like. In the case of the photoelectric converting film 72C that contains amorphous silicon, the photoelectric converting film 72C has a broad absorption spectrum and can absorb light emitted by the scintillator 71. In the case of the photoelectric converting film 72C that contains an organic photoelectric converting material, the photoelectric converting film 72C has a sharp absorption spectrum in the visible region, and hardly any electromagnetic waves other than the light emitted by the scintillator 71 are absorbed at the photoelectric converting film 72C, and generated noise can be effectively suppressed due to radiation such as X-rays or the like being absorbed at the photoelectric converting film 72C.

Quinacridone-based organic compounds and phthalocyanine-based organic compounds are examples of the organic photoelectric converting material. For example, because the absorption peak wavelength in the visible region of quinacridone is 560 nm, if quinacridone is used as the organic photoelectric converting material and CsI:Tl is used as the material of the scintillator 71, it is possible for the aforementioned difference in peak wavelengths to be kept within 5 nm, and the charge amount generated at the photoelectric converting film 72C can be made to be the substantial maximum. Organic photoelectric converting materials that can be used as the photoelectric converting film 72C are described in detail in Japanese Patent Application Laid-Open (JP-A) No. 2009-32854, and therefore, description thereof is omitted here. Note that the photoelectric converting film 72C may be formed so as to further include fullerene or carbon nanotubes.

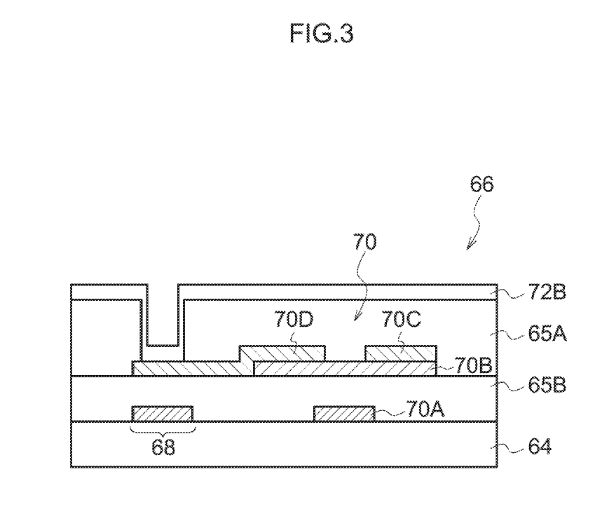

The structures of the TFT 70 and the storage capacitor 68 that are formed at the TFT substrate 66 relating to the present exemplary embodiment are shown schematically in FIG. 3.

The storage capacitors 68, that accumulate the charges that moved to the lower electrodes 72B, and the TFTs 70, that convert the charges accumulated in the storage capacitors 68 into electric signals and output the electric signals, are formed on the insulating substrate 64 in correspondence with the lower electrodes 72B. The region at which the storage capacitor 68 and the TFT 70 are formed has a portion that overlaps the lower electrode 72B in plan view. Due to such a structure, the storage capacitor 68 and the TFT 70, and the sensor portion 72 at each pixel portion overlap in the thickness direction, and the storage capacitor 68 and the TFT 70, and the sensor portion 72 can be disposed in a small surface area.

The storage capacitor 68 is electrically connected to the corresponding lower electrode 72B via a wire that is made of an electrically conductive material and is formed so as to pass through an insulating film 65A that is provided between the insulating substrate 64 and the lower electrode 72B. Due thereto, the charges that have been caught at the lower electrode 72B can be moved to the storage capacitor 68.

At the TFT 70, a gate electrode 70A, a gate insulating film 65B and an active layer (channel layer) 70B are layered. Further, a source electrode 70C and a drain electrode 70D are formed on the active layer 70B with a predetermined interval therebetween. The active layer 70B can be formed from, for example, amorphous silicon, an amorphous oxide, an organic semiconductor material, carbon nanotubes, or the like. Note that the material that structures the active layer 70B is not limited to these.

As amorphous oxides that structure the active layer 70B, oxides containing at least one of In, Ga and Zn (e.g., In—O type) are preferable, and oxides containing at least two of In, Ga and Zn (e.g., In—Zn—O type, In—Ga—O type, Ga—Zn—O type) are more preferable, and oxides containing In, Ga and Zn are particularly preferable. As In—Ga—Zn—O type amorphous oxides, amorphous oxides whose composition in a crystalline state is expressed by InGaO3(ZnO)m (where m is a natural number of less than 6) are preferable, and in particular, InGaZnO4 is more preferable. Note that the amorphous oxides that can structure the active layer 70B are not limited to these.

Phthalocyanine compounds, pentacene, vanadyl phthalocyanine, and the like are examples of organic semiconductor materials that can structure the active layer 70B, but the organic semiconductor materials are not limited to these. Note that structures of phthalocyanine compounds are described in detail in JP-A No. 2009-212389, and therefore, description thereof is omitted here.

If the active layer 70B of the TFT 70 is formed by an amorphous oxide, an organic semiconductor material, or carbon nanotubes, radiation such as X-rays or the like is not absorbed, or, even if radiation is absorbed, the absorption is limited to an extremely small amount, and therefore, the generation of noise can be effectively suppressed.

Further, when the active layer 70B is formed by carbon nanotubes, the switching speed of the TFT 70 can be made to be high-speed, and further, the TFT 70 that has a low absorption rate of light in the visible light region can be formed. Note that, when the active layer 70B is formed by carbon nanotubes, the performance of the TFT 70 markedly deteriorates merely due to an extremely small amount of metal impurities being mixed in the active layer 70B, and therefore, the active layer 70B must be formed by separating and extracting carbon nanotubes of extremely high purity by centrifugal separation or the like.

Here, with all of the aforementioned amorphous oxides, organic semiconductor materials and carbon nanotubes that structure the active layer 70B of the TFT 70, and the organic photoelectric converting materials that structure the photoelectric converting film 72C, film formation at a low temperature is possible. Accordingly, the insulating substrate 64 is not limited to substrates that are highly heat-resistant such as quartz substrates, glass substrates and the like, and flexible substrates of plastic or the like, and aramid and bionanofibers can also be used. Concretely, flexible substrates of polyesters such as polyethylene terephthalate, polybutylene phthalate, polyethylene naphthalate and the like, and polystyrene, polycarbonate, polyethersulfone, polyarylate, polyimide, polycycloolefin, norbornene resins, poly(chlorotrifluoroethylene) and the like can be used. If such a flexible substrate made of plastic is used, lightening of weight can be achieved, which is advantageous in terms of, for example, portability and the like. Note that an insulating layer for ensuring the insulating ability, a gas barrier layer for preventing passage of moisture and oxygen, an undercoat layer for improving smoothness and a tight fit with the electrodes and the like, or the like may be provided at the insulating substrate 64.

With aramid, high-temperature processes of greater than or equal to 200° C. can be applied, and therefore, a transparent electrode material can be cured at a high temperature and made to be low resistance. Further, aramid is suitable also for automatic packaging of a driver IC, including the solder reflow process. Moreover, because the thermal expansion coefficient of aramid is close to those of ITO (indium tin oxide) and glass substrates, there is little warping after manufacture, and aramid is difficult to break. Further, aramid can form substrates that are thin as compared with glass substrates or the like. Note that the insulating substrate 64 may be formed by layering an ultra-thin glass substrate and aramid.

Bio-nanofibers are fibers in which a cellulose microfibril bundle (bacteria cellulose) produced by bacteria (acetic acid bacterium, Acetobacter Xylinum), and a transparent resin are compounded. When the cellulose microfibril bundle has a width of 50 nm, the cellulose microfibril bundle is a size of 1/10 with respect to the visible light wavelength, and has high strength, high elasticity, and low thermal expansion. By impregnating and hardening a transparent resin, such as an acrylic resin, an epoxy resin or the like, in bacteria cellulose, bio-nanofibers that exhibit light transmittance of about 90% at a wavelength of 500 nm while containing up to 60 to 70% fiber, are obtained. Bio-nanofibers have a low thermal expansion coefficient (3-7 ppm) that is comparable to that of silicon crystal, have strength (460 MPa) to the same extent as that of steel, have high elasticity (30 GPa), and are flexible. Therefore, the insulating substrate 64 can be formed to be thin as compared with a glass substrate or the like.

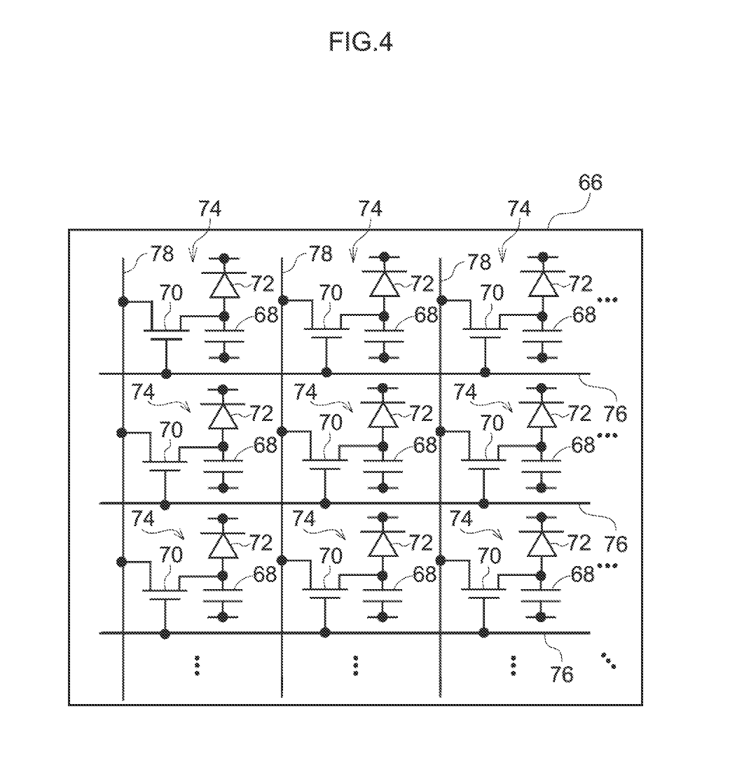

A plan view showing the structure of the TFT substrate 66 relating to the present exemplary embodiment is shown in FIG. 4.

Plural pixels 74, that are structured to include the above-described sensor portions 72, storage capacitors 68 and TFTs 70, are provided at the TFT substrate 66 in a two-dimensional form in a given direction (the row direction in FIG. 4) and in a direction (the column direction in FIG. 4) intersecting the given direction.

Plural gate lines 76 that extend in the given direction (the row direction) and are for turning the respective TFTs 70 on and off, and plural data lines 78 that extend in the intersecting direction (the column direction) and are for reading-out charges via the TFTs 70 that are in on states, are provided at the TFT substrate 66.

The radiation detector 60 is flat-plate shaped, and, in plan view, forms a quadrilateral shape having four sides at the outer edge thereof. Concretely, the radiation detector 60 is formed in a rectangular shape.

As shown in FIG. 2, the radiation detector 60 relating to the present exemplary embodiment is formed by the scintillator 71 being affixed to the surface of this TFT substrate 66.

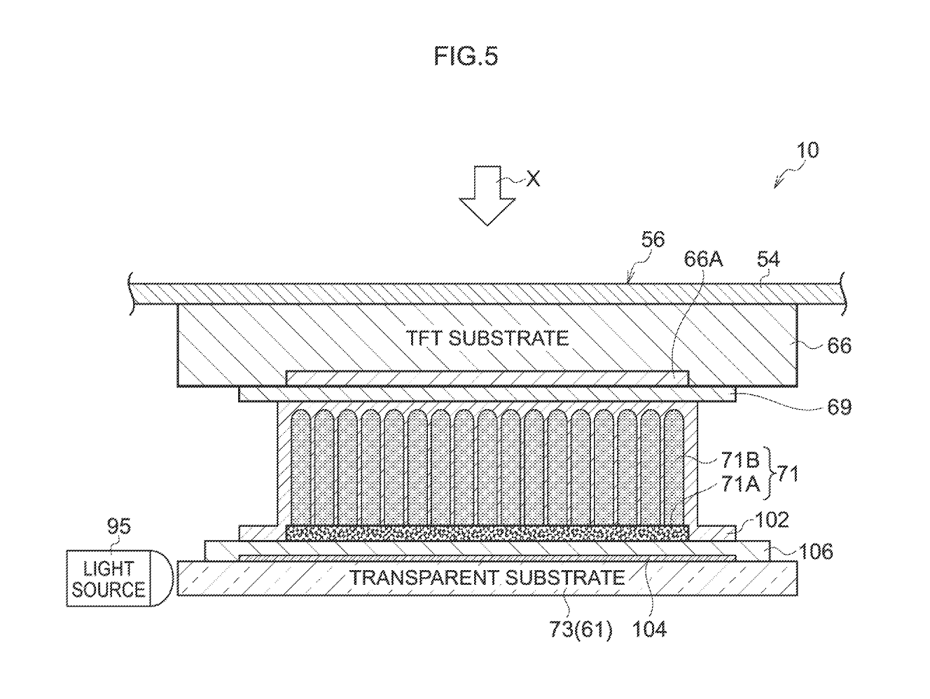

A side view schematically showing the structure of the interior of the electronic cassette 10 relating to the first exemplary embodiment is shown in FIG. 5. Note that, in FIG. 5, in order to make it easy to identify an imaging region 66A of the TFT substrate 66 at which the plural pixels 74 are provided in a two-dimensional form, the imaging region 66A is illustrated as a layer.

Within the electronic cassette 10, the radiation detector 60 is disposed such that the TFT substrate 66 side thereof faces the surface, at the side opposite the surface on which the radiation X is incident, of the top plate portion of the housing 54 at which is provided the image-capturing surface 56 on which the radiation that has passed through the object of imaging is irradiated.

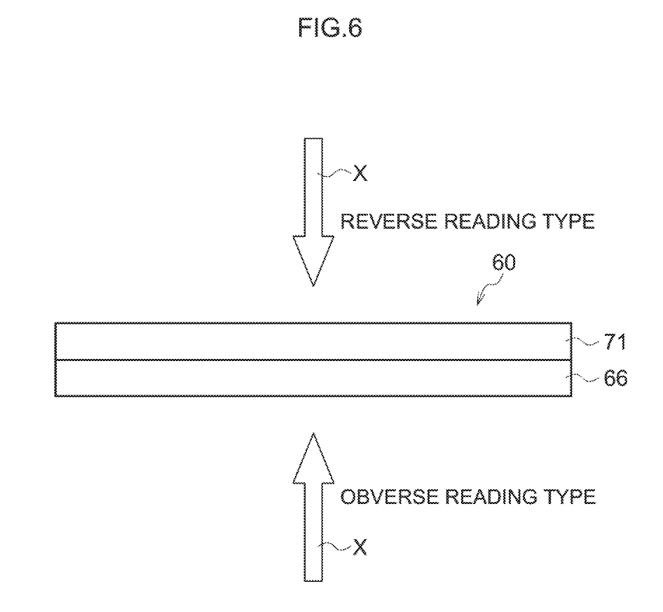

Here, as shown in FIG. 6, when the radiation detector 60 is a so-called reverse reading type (a so-called PSS (Penetration Side Sampling) type) in which radiation is irradiated from the side at which the scintillator 71 is formed and the radiographic image is read from the TFT substrate 66 that is provided at the reverse surface side of the incident surface of the radiation, light is emitted more strongly at the top surface side, in the drawing, of the scintillator 71 (the side opposite the TFT substrate 66). When the radiation detector 60 is a so-called obverse reading type (a so-called ISS (Irradiation Side Sampling) type) in which radiation is irradiated from the TFT substrate 66 side and the radiographic image is read from the TFT substrate 66 that is provided at the obverse surface side of the incident surface of the radiation, the radiation that has passed through the TFT substrate 66 is incident on the scintillator 71, and the TFT substrate 66 side of the scintillator 71 emits light more strongly. At the respective sensor portions 72 that are provided at the TFT substrate 66, charges are generated by the light generated at the scintillator 71. Therefore, when the radiation detector 60 is an obverse reading type, the light emitting position of the scintillator 71 with respect to the TFT substrate 66 is closer and therefore the resolution of the radiographic image obtained by imaging is higher, than when the radiation detector 60 is a reverse reading type.

In the present exemplary embodiment, the radiation detector 60 is disposed within the electronic cassette 10 so as to be an obverse reading type with respect to the radiation X that is incident from the image-capturing surface 56.

At this indirect-conversion-type radiation detector 60, there are cases in which, at the photoelectric converting films 72C of the respective sensor portions 72 of the TFT substrate 66, charges become trapped once in the impurity levels, and residual images arise due to the trapped charges being released.

Thus, in order to illuminate light that erases residual images at the radiation detector 60, in the present exemplary embodiment, the vapor deposition substrate 73 of the scintillator 71 is made to be a light-transmissive substrate that is light-transmissive. The vapor deposition substrate 73 may be any substrate provided that it is light-transmissive and is heat-resistant with respect to the heat at the time of vapor deposition. For example, a glass substrate, a transparent ceramic substrate, or the like can be used as the vapor deposition substrate 73. Note that the vapor deposition substrate 73 is not limited to these materials.

A light source 95 is disposed at one side surface of the vapor deposition substrate 73. Light from the light source 95 is incident on the vapor deposition substrate 73. In the present exemplary embodiment, the vapor deposition substrate 73 is made to be a light-transmissive substrate and is made to function as the light guide plate 61. The light from the light source 95 is led by the vapor deposition substrate 73 to the respective pixels 74 of the imaging region 66A of the TFT substrate 66.

However, when the vapor deposition substrate 73 is made to be a transparent substrate, the light that is generated at the scintillator 71 passes-through the vapor deposition substrate 73, and the efficiency of utilization of light deteriorates.

Thus, in the present exemplary embodiment, a half-mirror layer 104, that mainly reflects light of the wavelength band generated at the scintillator 71 and mainly transmits light of the wavelength band guided by the vapor deposition substrate 73, is formed on the vapor deposition substrate 73 to a size that is larger than the imaging region 66A. A protective layer 106 that is light-transmissive is formed in order to protect the half-mirror layer 104, and the scintillator 71 is formed thereon. For example, the half-mirror layer 104 may be formed of a metal such as Ag, Al, NiAl and the like. Further, the half-mirror layer 104 may be formed to a film thickness of from greater than or equal to 2 nm to less than or equal to 100 nm. The material and the film thickness of the half-mirror layer 104 are selected appropriately such that the reflectance of the light of the wavelength range that is converted by the scintillator 71 is higher than the transmittance of the light of the wavelength range that is illuminated from the light source 95. For example, by using CsI:Tl having a peak wavelength at 565 nm as the scintillator 71, by using an LED that emits infrared light having a peak wavelength at 950 nm as the light source 95, and by using the half-mirror 104 made of Al and having a thickness of 10 nm, it can be accomplished that the reflectance of light converted by the scintillator 71 is substantially 50% and the transmittance of light illuminated by the light source 95 is substrantially 50%. Further, by using the half-mirror having a thickness of 5 nm, it can be accomplished that the reflectance of light converted by the scintillator 71 is substantially 70% and the transmittance of light illuminated by the light source 95 is substantially 30%.

It is preferable that the reflectance of light converted by the scintillator 71 and the transmittance of light illuminated by the light source 95 is greater. It is more preferable that they are greater than or equal to 50%, and it is rather preferable that they are greater than or equal to 70%.

Here, it should be noted that the reflectance and the transmittance of light in the present embodiment can be measured by a widely used spectrophotometer, for example, U-4100 model spectrophotometer manufactured by HITACHI.

Further, in the same way as the sealing portion 102, an organic film obtained by vapor phase polymerization such as thermal CVD, plasma CVD or the like, for example, is used as the protective layer 106.

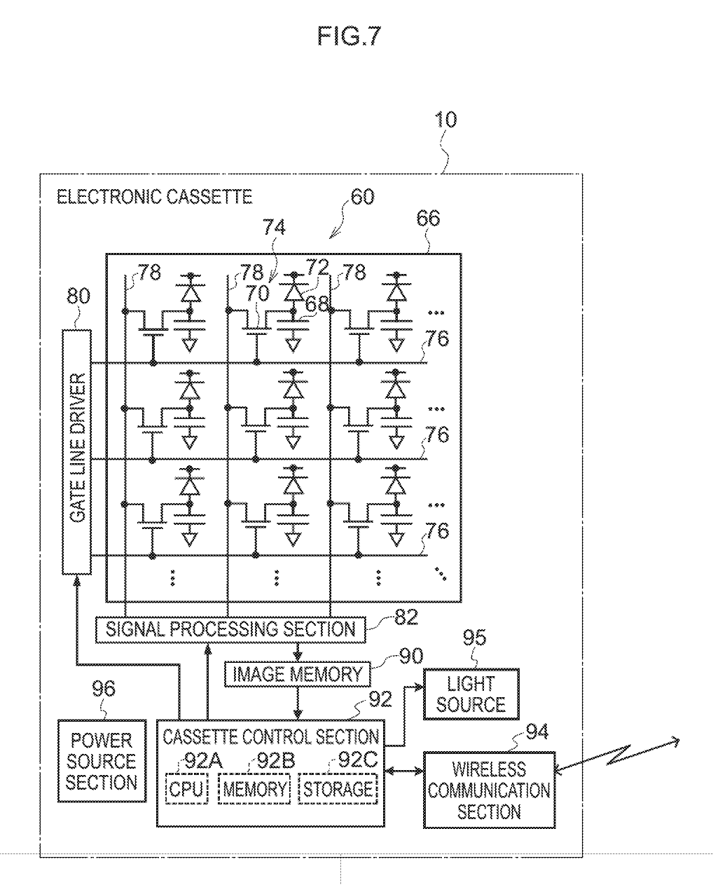

A block diagram showing the structure of main portions of the electrical system of the electronic cassette 10 relating to the first exemplary embodiment is shown in FIG. 7.

As described above, the numerous pixels 74, which are provided with the sensor portions 72, the storage capacitors 68 and the TFTs 70, are arranged in the form of a matrix at the radiation detector 60. The charges, which are generated at the sensor portions 72 accompanying the irradiation of the radiation X onto the electronic cassette 10, are accumulated in the storage capacitors 68 of the individual pixels 74. Due thereto, the image information, that is carried by the radiation X that was irradiated onto the electronic cassette 10, is converted into charge information and held at the radiation detector 60.

Further, the individual gate lines 76 of the radiation detector 60 are connected to a gate line driver 80, and the individual data lines 78 are connected to a signal processing section 82. When charges are accumulated in the storage capacitors 68 of the individual pixels 74, the TFTs 70 of the individual pixels 74 are turned on in order in units of a row by signals supplied from the gate line driver 80 via the gate lines 76, and the charges, that are accumulated in the storage capacitors 68 of the pixels 74 at which the TFTs 70 have been turned on, are transferred through the data lines 78 as analog electric signals, and are inputted to the signal processing section 82. Accordingly, the charges accumulated in the storage capacitors 68 of the individual pixels 74 are read-out in order in row units.

The signal processing section 82 has an amplifier and a sample/hold circuit for each of the individual data lines 78. The electric signals transferred through the individual data lines 78 are amplified at the amplifiers, and thereafter, are held by the sample/hold circuits. A multiplexer and an A/D (analog/digital) converter are connected in that order to the output sides of the sample/hold circuits. The electric signals held in the individual sample/hold circuits are inputted in order (serially) to the multiplexer, and are converted into digital data by the A/D converter.

An image memory 90 is connected to the signal processing section 82. The digital data outputted from the A/D converter of the signal processing section 82 is stored in order in the image memory 90. The image memory 90 has a storage capacity that can store image data of an amount corresponding to plural frames. Each time capturing of a radiographic image is carried out, the digital data of the respective pixels 74 of the radiation detector 60 are successively stored as image data in the image memory 90.

The image memory 90 is connected to a cassette control section 92 that controls the overall operation of the electronic cassette 10. The cassette control section 92 is structured to include a microcomputer, and has a CPU (Central Processing Unit) 92A, a memory 92B including a ROM (Read Only Memory) and a RAM (Random Access Memory), and a nonvolatile storage 92C formed from an HDD (Hard Disk Drive), a flash memory, or the like.

The light source 95 is connected to the cassette control section 92. The cassette control section 92 can control the light emission of the light source 95.

Further, a wireless communication section 94 is connected to the cassette control section 92. The wireless communication section 94 relating to the present exemplary embodiment corresponds to wireless LAN (Local Area Network) standards such as IEEE (Institute of Electrical and Electronics Engineers) 802.11a/b/g/n or the like, and controls the transfer of various types of information to and from external devices by wireless communication. The cassette control section 92 can communicate wirelessly with external devices via the wireless communication section 94, and the transmission and reception of various types of information to and from a control device, such as a console or the like, is possible.

A power source section 96 is provided at the electronic cassette 10. The above-described various types of circuits and respective elements (the gate line driver 80, the signal processing section 82, the image memory 90, the wireless communication section 94, the cassette control section 92, the light source 95, and the like) are operated by electric power supplied from the power source section 96. The power source section 96 incorporates therein the aforementioned battery (secondary battery) 96A so that the portability of the electronic cassette 10 is not impaired, and supplies electric power from the charged battery 96A to the various types of circuits and respective elements. Note that, in FIG. 7, illustration of the wires that connect the power source section 96 with the various types of circuits and respective elements is omitted.

Operation of the electronic cassette 10 relating to the present exemplary embodiment is described next.

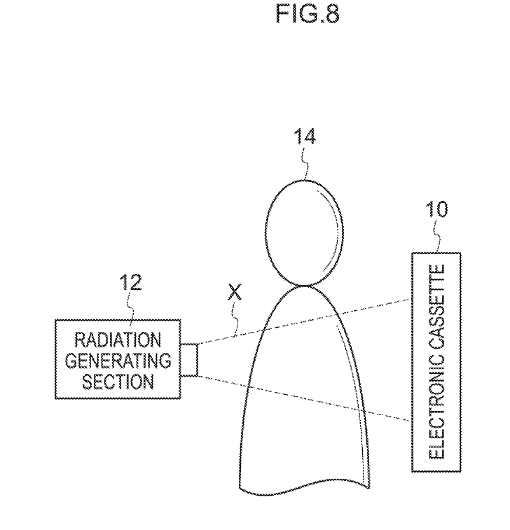

At the time of capturing a radiographic image, as shown in FIG. 8, the electronic cassette 10 is disposed with an interval between the electronic cassette 10 and a radiation generating section 12 that serves as a radiation source and generates the radiation X. The space between the radiation generating section 12 and the electronic cassette 10 at this time is an imaging position at which a patient 14 who serves as a subject is positioned. When capturing of a radiographic image is instructed, the radiation generating section 12 emits the radiation X of a radiation amount corresponding to imaging conditions or the like that have been provided in advance. Due to the radiation X that is emitted from the radiation generating section 12 passing through the patient 14 who is positioned at the imaging position, the radiation X carries image information, and thereafter, is irradiated onto the electronic cassette 10.

At the radiation detector 60, the scintillator 71 emits light accompanying the irradiation of the radiation X.

Here, in the present exemplary embodiment, the scintillator 71 is formed from columnar crystals. The light generated at the scintillator 71 is guided by the gaps between the columnar crystals of the columnar crystal region 71B, and exits toward the TFT substrate 66 side. In this way, due to the light being guided at the scintillator 71 by the gaps between the columnar crystals and being led toward the TFT substrate 66 side, diffusion of light is suppressed, and therefore, blurring of the radiographic image detected by the radiation detector 60 can be suppressed. Further, the light that reaches the deep portion (the non columnar-crystal region 71A) of the scintillator 71 also is partially reflected at the non columnar-crystal region 71A toward the TFT substrate 66 side, and therefore, the light amount of the light that is incident on the TFT substrate 66 is improved. Moreover, the light that is transmitted through the non columnar-crystal region 71A also is reflected toward the TFT substrate 66 side by the half-mirror layer 104 that is provided between the vapor deposition substrate 73 and the vapor deposition substrate 73, and therefore, the light amount of the light that is incident on the TFT substrate 66 improves.

At the radiation detector 60, charges are generated at the sensor portions 72 of the respective pixels 74 due to the light generated at the scintillator 71, and the generated charges are accumulated in the storage capacitors 68. Due thereto, the image information, that was carried by the radiation X that was irradiated on the electronic cassette 10, is converted into charge information, and is held at the radiation detector 60.

When the radiation X is irradiated, the cassette control section 92 of the electronic cassette 10 controls the gate line driver 80 such that on signals are outputted from the gate line driver 80 to the respective gate lines 76 in order and line-by-line, and the respective TFTs 70 that are connected to the respective gate lines 76 are turned on in order and line-by-line.

At the radiation detector 60, when the respective TFTs 70 that are connected to the respective gate lines 76 are turned on in order and line-by-line, the charges that are accumulated in the respective storage capacitors 68 flow-out in order and line-by-line to the respective data lines 78 as electric signals. The electric signals, which have flowed-out to the respective data lines 78, are converted into digital image data at the signal processing section 82, and are stored in the image memory 90.

After imaging is finished, the cassette control section 92 transmits the image information stored in the image memory 90 to the console by wireless communication.

At the radiation detector 60, there are cases in which charges becomes trapped once in the impurity levels at the photoelectric converting films 72C of the respective sensor portions 72, and residual images arise due to the trapped charges being released. Thus, at the time of carrying out image capturing, the cassette control section 92 carries out light calibration in which the light source 95 is made to emit light, the light is illuminated onto the TFT substrate 66 via the vapor deposition substrate 73, and the impurity potentials of the sensor portions 72 of the respective pixels 74 of the radiation detector 60 are filled-in before imaging. The light that is generated at the light source 95 is led to the radiation detector 60 via the vapor deposition substrate 73, and passes through the half-mirror layer 104 and is incident on the scintillator 71, and is illuminated onto the TFT substrate 66 via the scintillator 71.

In this way, in the present exemplary embodiment, by providing the half-mirror layer 104 between the vapor deposition substrate 73 and the vapor deposition substrate 73 that functions as the light guide plate 61, the light that is generated at the scintillator 71 can be reflected at the half-mirror layer 104 toward the TFT substrate 66 side. Therefore, the amount of light that is incident on the TFT substrate 66 is improved. Further, in the present exemplary embodiment, by providing the half-mirror layer 104 between the vapor deposition substrate 73 and the vapor deposition substrate 73, the light for light calibration, which is illuminated from the scintillator 71 side, is transmitted through at the half-mirror layer 104 and can be illuminated onto the TFT substrate 66, and therefore, residual images can be erased.

### Second Exemplary Embodiment

A second exemplary embodiment is described next.

The structure of the electronic cassette 10 and the structure of the TFT substrate 66 relating to the second exemplary embodiment are the same as those of the above-described first exemplary embodiment (see FIG. 1 through FIG. 4 and FIG. 7), and therefore, description thereof is omitted here.

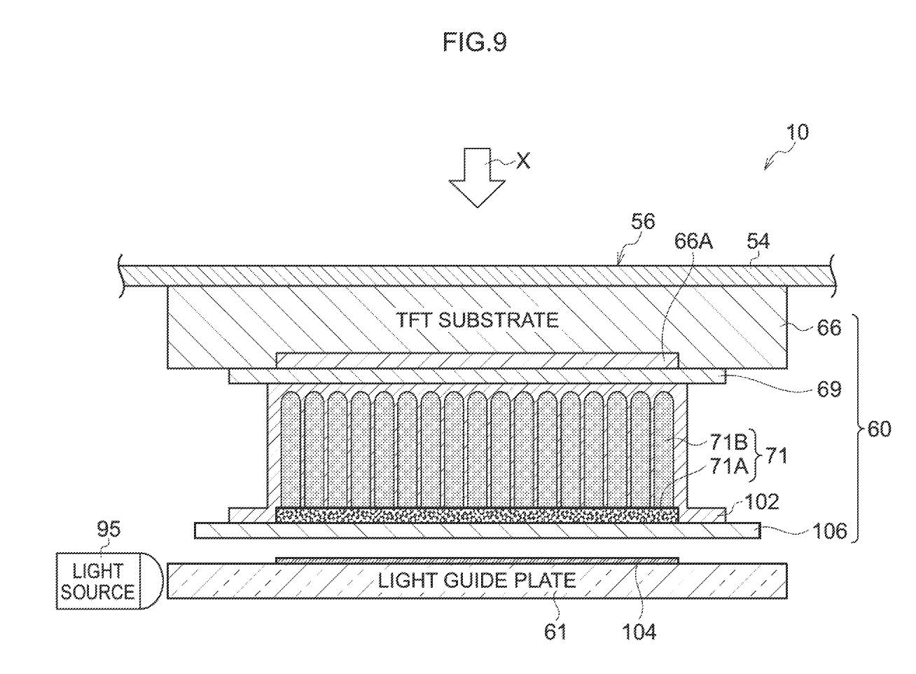

A side view schematically showing the structure of the interior of the electronic cassette 10 relating to the second exemplary embodiment is shown in FIG. 9. Note that portions that are the same as those of the first exemplary embodiment (FIG. 5) are denoted by the same reference numerals, and description thereof is omitted.

In the present exemplary embodiment, the scintillator 71 and the sealing portion 102 are formed on the vapor deposition substrate 73 at which the protective layer 106 is formed, and, due to the scintillator 71 being peeled-off from the vapor deposition substrate 73 at the protective layer 106, only the scintillator 71 is affixed to the TFT substrate 66, without providing the vapor deposition substrate 73. Note that the peeling-off from the vapor deposition substrate 73 at the protective layer 106 may be carried out before the affixing to the TFT substrate 66 or after the affixing to the TFT substrate 66.

The light guide plate 61 that is flat-plate-shaped is disposed at the scintillator 71 side of the radiation detector 60. Note that, in the present exemplary embodiment, the light guide plate 61 is disposed such that there is a gap between the scintillator 71 and the light guide plate 61, and an air layer is provided between the scintillator 71 and the light guide plate 61. However, the scintillator 71 and the light guide plate 61 may be disposed so as to contact one another, without an air layer being provided. Reflectance is improved by providing an air layer between the scintillator 71 and the light guide plate 61 in this way.

The half-mirror layer 104 is formed, to a size that is larger than the imaging region 66A, at the radiation detector 60 side surface of the light guide plate 61.

In the radiation detector 60 relating to the present exemplary embodiment as well, the scintillator 71 emits light accompanying the irradiation of the radiation X. A portion of the light that is generated at the scintillator 71 is transmitted through the non columnar-crystal region 71A, but is reflected toward the TFT substrate 66 side by the half-mirror layer 104 that is provided between the vapor deposition substrate 73 and the light guide plate 61. Therefore, the amount of light that is incident on the TFT substrate 66 improves.

Further, in the present exemplary embodiment, also when light calibration is carried out due to the light source 95 being made to emit light, the light for light calibration that is illuminated from the scintillator 71 side is transmitted through at the half-mirror layer 104 and can be illuminated onto the TFT substrate 66. Therefore, residual images can be erased.

### Third Exemplary Embodiment

A third exemplary embodiment is described next.

Other than the fact that the positions of the radiation detector 60 and the light guide plate 61 are reversed, the electronic cassette 10 relating to the third exemplary embodiment is the same as in the above-described first exemplary embodiment (see FIG. 1), and therefore, description thereof is omitted here. Further, because the structure of the TFT substrate 66 is the same as in the above-described first exemplary embodiment (see FIG. 2 through FIG. 4 and FIG. 7), description thereof is omitted here.

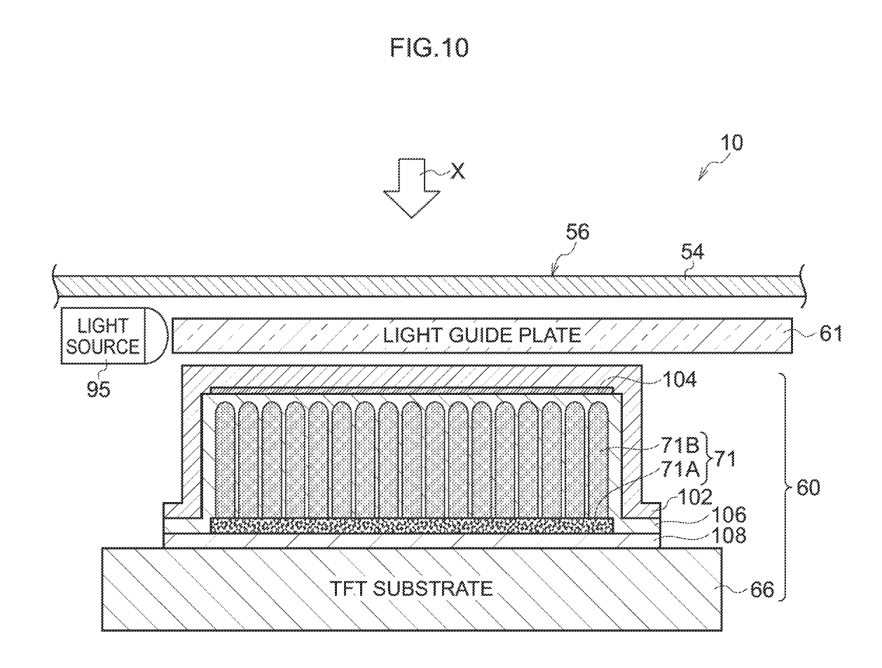

A side view schematically showing the structure of the interior of the electronic cassette 10 relating to the third exemplary embodiment is shown in FIG. 10. Note that portions that are the same as those of the first exemplary embodiment (FIG. 5) are denoted by the same reference numerals, and description thereof is omitted.

In the radiation detector 60 relating to the present exemplary embodiment, the scintillator 71 is formed on the TFT substrate 66 by vapor deposition of a material such as CsI:Tl or the like on the TFT substrate 66 on which is formed an underlayer 108 that is light-transmissive. At the scintillator 71 on the TFT substrate 66, the non columnar-crystal region 71A is formed at the TFT substrate 66 side, and the columnar crystal region 71B, which is formed from columnar crystals, is formed at the distal end side.

At the radiation detector 60, the half-mirror layer 104 is formed on the scintillator 71. The protective layer 106 that is light-transmissive is formed on the entire surface so as to cover the half-mirror layer 104.

The radiation detector 60 is disposed within the electronic cassette 10 such that the scintillator side 71 faces the image-capturing surface 56 side of the housing 54. Namely, in the present exemplary embodiment, the radiation detector 60 is disposed within the electronic cassette 10 so as to be a reverse reading type with respect to the radiation X that is incident from the image-capturing surface 56.

The light guide plate 61 that is flat-plate-shaped is disposed between the radiation detector 60 and the image-capturing surface 56 of the housing 54.

At the radiation detector 60 relating to the present exemplary embodiment as well, the scintillator 71 emits light accompanying irradiation of the radiation X. The light generated at the scintillator 71 is guided by the gaps between the columnar crystals of the columnar crystal region 71B and is led toward the light guide plate 61 side, but is reflected toward the TFT substrate 66 side by the half-mirror layer 104 that is formed on the scintillator 71. Therefore, the amount of light that is incident on the TFT substrate 66 improves.

Further, in the present exemplary embodiment, also when light calibration is carried out due to the light source 95 being made to emit light, the light for light calibration that is illuminated from the scintillator 71 side is transmitted at the half-mirror layer 104 and can be illuminated onto the TFT substrate 66. Therefore, residual images can be erased.

The present invention is described above by using the first through third exemplary embodiments, but the technical scope of the present invention is not limited to the ranges described in the above respective exemplary embodiments. Various modifications and improvements can be added to the above-described exemplary embodiments within a range that does not deviate from the gist of the present invention, and forms to which such modifications or improvements have been added are also encompassed in the technical scope of the present invention.

Further, the above-described exemplary embodiments do not limit the inventions relating to the claims, nor is it the case that all of the combinations of features described in the exemplary embodiments are essential to the means of the present invention for solving the problems of the prior art. Inventions of various stages are included in the above exemplary embodiments, and various inventions can be extracted from appropriate combinations of plural constituent features that are disclosed. Even if some of the constituent features are omitted from all of the constituent features that are shown in the exemplary embodiments, such structures from which some constituent features are omitted can be extracted as inventions provided that the effects of the present invention are obtained thereby.

For example, the above respective exemplary embodiments describe cases in which the present invention is applied to the electronic cassette 10 that is a portable radiographic imaging device, but the present invention is not limited to the same and may be applied to a stationary radiographic imaging device.

Further, the above-described respective exemplary embodiments describe cases in which, when image capturing is carried out, the light source 95 is made to emit light, and the light is illuminated via the light guide plate 61 onto the respective pixels 74 of the TFT substrate 66. However, the present invention is not limited to the same. For example, light-emitting elements, such as light-emitting diodes or organic EL elements or the like, may be disposed so as to face the scintillator 71 side of the radiation detector 60, and light of the wavelength region in which the sensor portions 72 have sensitivity may be directly illuminated from the light-emitting elements.

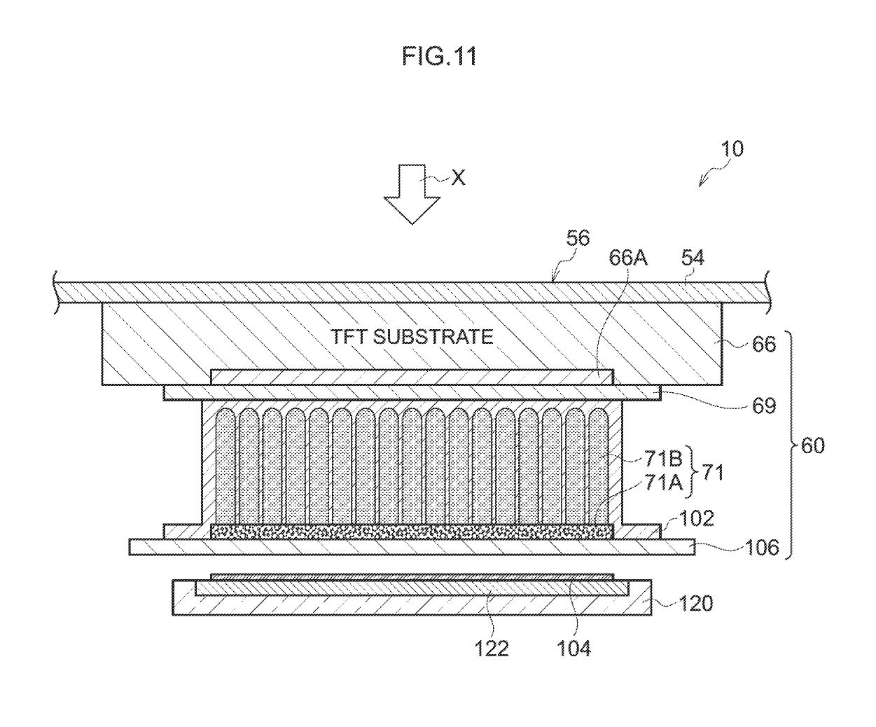

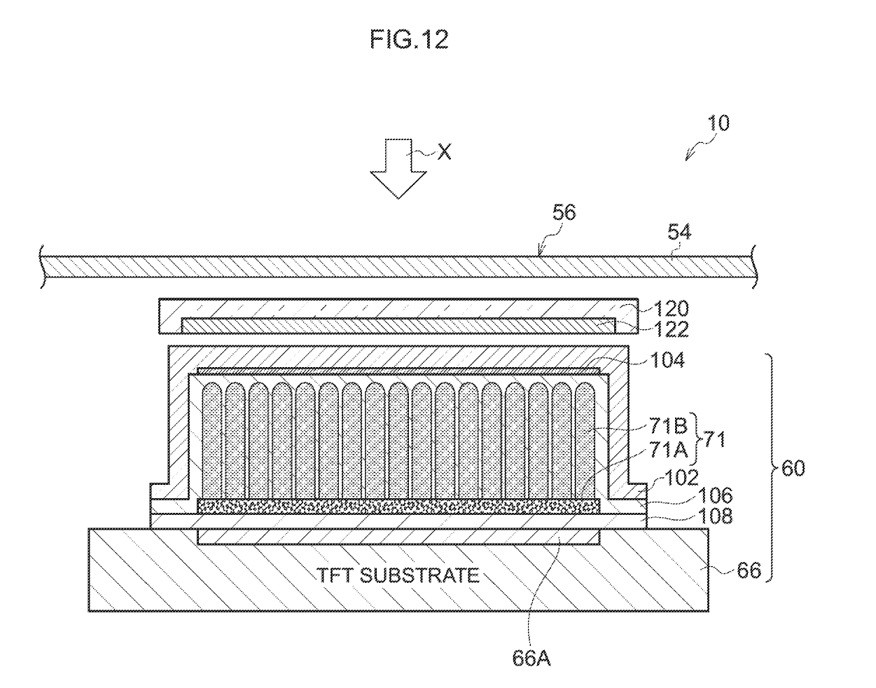

FIG. 11 and FIG. 12 show cases in which, instead of the light guide plate 61 and the light source 95, a light-emitting panel 120 at which a light-emitting section 122 is provided is disposed at the scintillator 71 side of the radiation detector 60, and light is directly illuminated from the light-emitting section 122.

Organic EL elements hardly absorb any radiation at all. Therefore, in a case in which this light-emitting section 122 that illuminates light for light calibration is structured by organic EL elements for example, the amount of absorption of radiation by the organic EL elements is small even when, as shown in FIG. 12, the light-emitting panel 120 is disposed at the radiation incident side of the radiation detector 60 and radiation that is transmitted through the light-emitting panel 120 is incident on the radiation detector 60. Therefore, a decrease in sensitivity with respect to radiation can be suppressed.

Further, in the obverse reading method, radiation passes through the TFT substrate 66 and reaches the scintillator 71. However, when the photoelectric converting films 72C of the TFT substrate 66 are structured from an organic photoelectric converting material, there is hardly any absorption of radiation at the photoelectric converting films 72C, and damping of the radiation can be kept small.

At the radiation detector 60, when the photoelectric converting films 72C are formed of an organic photoelectric converting material, film formation of the photoelectric converting films 72C at a low temperature is possible. Therefore, a flexible substrate of plastic or the like, or aramid or bio-nanofibers can be used as the insulating substrate 64. Due thereto, the radiation detector 60 can be formed to be thin while also being load-resistant. Due thereto, as shown in FIG. 5, when the radiation detector 60 is mounted to the surface, at the opposite side of the surface on which radiation is incident, of the top plate portion of the housing 54 at which is provided the image-capturing surface 56 on which the radiation that has passed through the object of imaging is irradiated, the distance between the radiation detector 60 and the top plate portion, at which the image-capturing surface 56 is provided, of the housing 54 can be kept to be small. Further, because the radiation detector 60 can be provided with load-resistance, the radiation detector 60 can withstand load from the top plate portion.

Moreover, the half-mirror layer 104 may be formed so as to mainly reflect light of a specific wavelength region, and mainly transmit light of wavelengths other than the specific wavelength region.

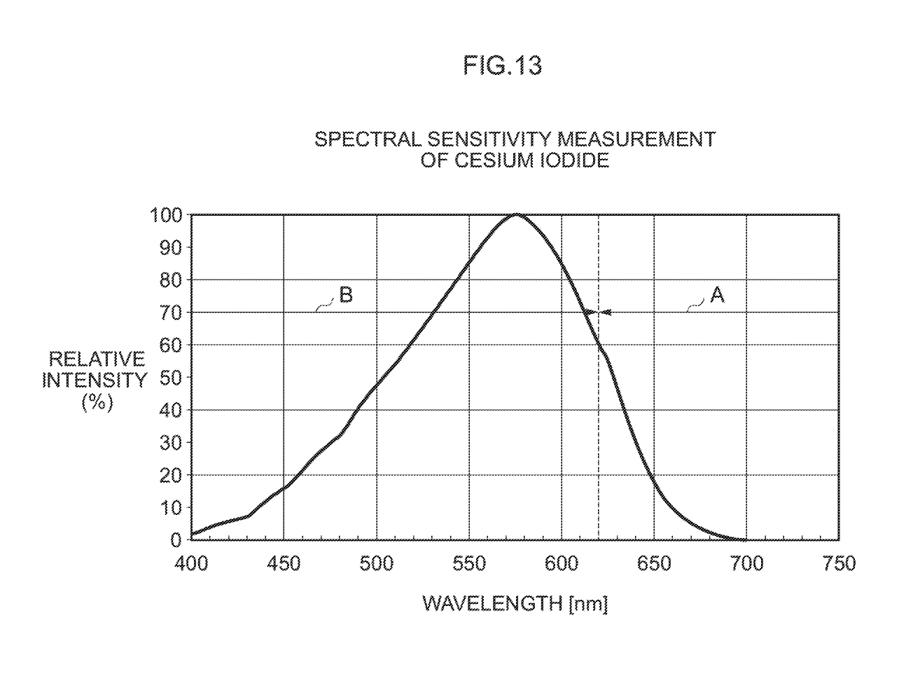

A graph showing the distribution of the emission wavelengths of CsI(Tl) is shown in FIG. 13.

The peak of the emission wavelengths of CsI(Tl) is 565 nm, but light of various wavelengths from the blue color region to the infrared light region are generated.

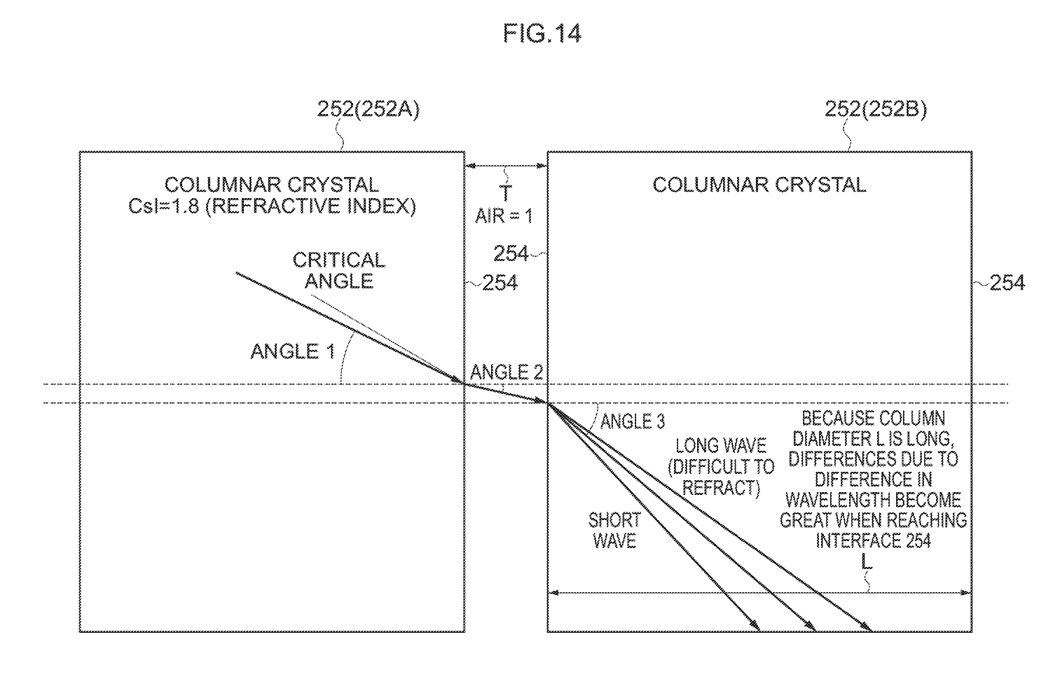

Further, when the scintillator 71 is formed of CsI(Tl) columnar crystals, light is generated within the respective columnar crystals due to radiation being irradiated. As shown in FIG. 14, when an incidence angle θ, at which the light that is generated within a columnar crystal 252 is incident on an interface 254 with the exterior of the columnar crystal 252, exceeds a critical angle (e.g., 34°) at which the light is totally reflected, the light is totally reflected within the columnar crystal 252. When the incidence angle θ is less than the critical angle, a portion of the light is transmitted through to the exterior. Therefore, as shown in FIG. 14, there are cases in which light, which is transmitted through a columnar crystal 252A, is incident on an adjacent columnar crystal 252B. At this light that is transmitted through, refraction arises at the interface 254, and the advancing direction changes. The relationship angle 1>angle 2<angle 3 exists among angle 1 at which the light, that is generated at the columnar crystal 252A and is transmitted to the exterior, is incident on the interface 254, and angle 2 at which that light exits from the interface 254, and angle 3 at which the light that was transmitted-through exits from the interface 254 of the adjacent columnar crystal 252B. Further, the change in the angle of the advancing direction due to refraction, and here, the change in angle 3 with respect to angle 1, is greater the shorter the wavelength of the light, and is smaller the longer the wavelength of the light. With respect to the light that is transmitted to the columnar crystal 252B, the longer the wavelength, the smaller the change in angle due to refraction, and therefore, the higher the probability of not being totally reflected at the interface 254 of the columnar crystal 254B and being transmitted through again. Note that FIG. 14 illustrates a case in which the fill factor of the columnar crystals 252 is high (e.g., 80%), and, because interval T between the columnar crystals 252 is short, the paths of lights between the columnar crystals 252 are considered to be the same regardless of the wavelength.

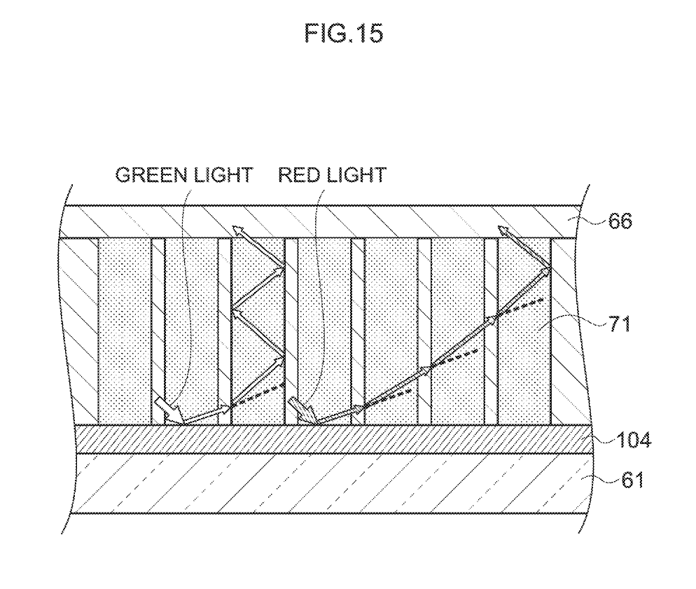

Therefore, as shown in FIG. 15, when the green light and the red light generated within the columnar crystals 252 are both reflected at the half-mirror layer 104, the green light and the red light are transmitted through the columnar crystals 252 until the respective angles of incidence thereof on the interface 254 become less than or equal to the critical angle. When the angles of incidence onto the interface 254 become less than or equal to the critical angle, the green light and the red light are totally reflected within the columnar crystals 252. However, because the change in the angle of the advancing direction due to refraction is smaller for the red light than the green light, the red light reaches a position that is further away. Therefore, the phenomenon of light being incident on the sensor portion 72 of another pixel 74 arises more easily with red light than with green light.

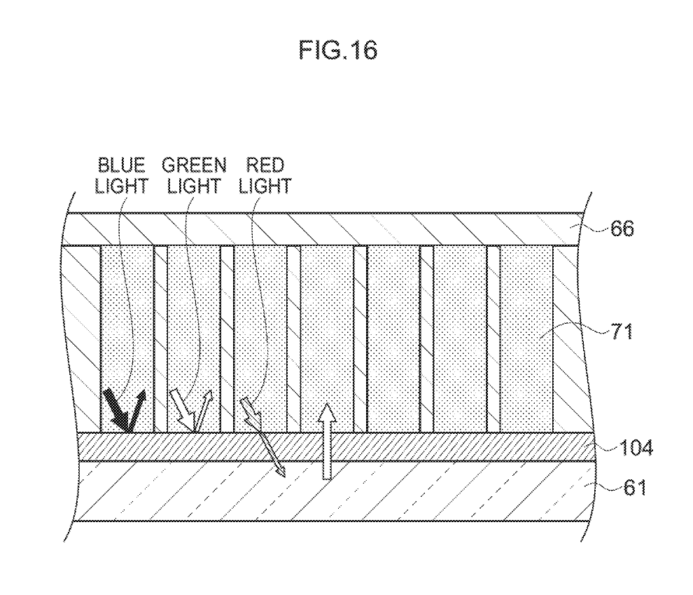

Thus, for example, as shown in FIG. 13, when the half-mirror layer 104 mainly transmits light of long wavelength region A (e.g., light of greater than or equal to 620 nm), at which it is easy for red light or infrared light or the like to reach a far position, and mainly reflects light of wavelength region B that includes the peak wavelength and that is shorter than wavelength region A, as shown in FIG. 16, of the light that is generated at the scintillator 71, the light of long wavelength region A, such as red light or infrared light or the like, is transmitted through the half-mirror layer 104, and therefore, the MTF characteristic can be improved. Further, light calibration of the sensor portions 72 of the respective pixels 74 of the radiation detector 60 can be carried out also by causing light, that is transmitted through the half-mirror layer 104 such as red light or the like, to be illuminated as the light for light calibration from the light guide plate 61 and the light source 95 or the light-emitting section 122.

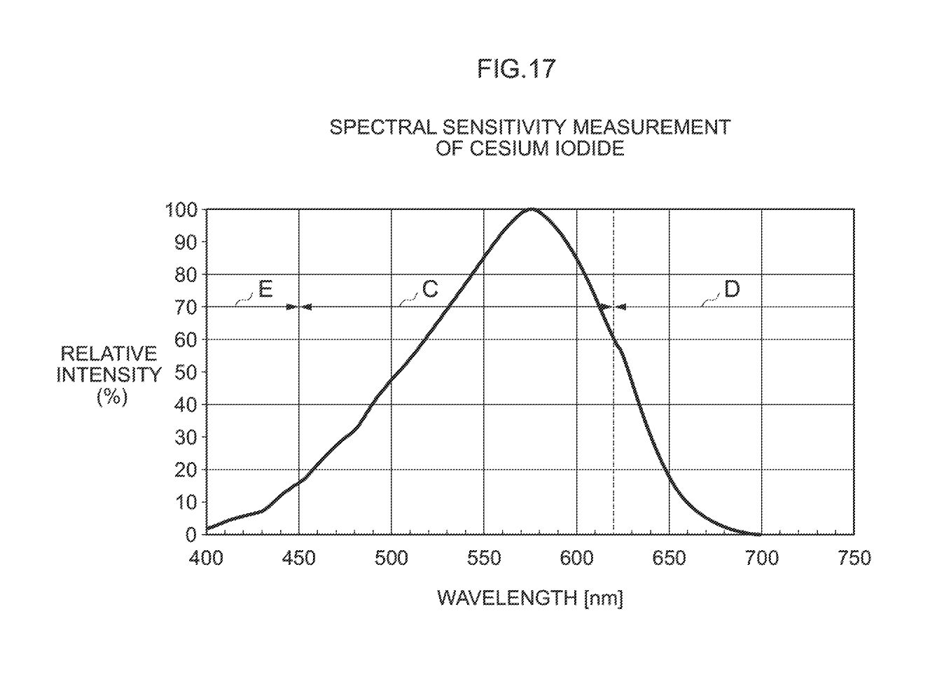

Further, the half-mirror layer 104 may be formed as shown in FIG. 17 so as to mainly reflect light of wavelength region C of a predetermined range (e.g., 450 nm to 620 nm) that includes the peak wavelength and excludes the wavelength regions that are less than or equal to ultraviolet light and greater than or equal to red light, and mainly transmit light of wavelength region D that is greater than or equal to red light whose wavelength is greater than wavelength region C, and light of wavelength region E that is less than or equal to ultraviolet light whose wavelength is smaller than wavelength region C. Due thereto, light of wavelength region D, that is longer than red light and infrared light and the like, is transmitted through the half-mirror layer 104, and therefore, the MTF characteristic can be improved. Further, CsI(Tl) emits light due to light, that is in the wavelength region shorter than blue color, being illuminated. Therefore, when the scintillator 71 is made to be columnar crystals of CsI(Tl), and light (e.g., ultraviolet light) of a wavelength region shorter than blue color is illuminated as the light for light calibration from the light guide plate 61 and the light source 95 or the light-emitting section 122, the light of a wavelength region shorter than blue color is transmitted through the half-mirror layer 104, and therefore, the scintillator 71 can be made to emit light.

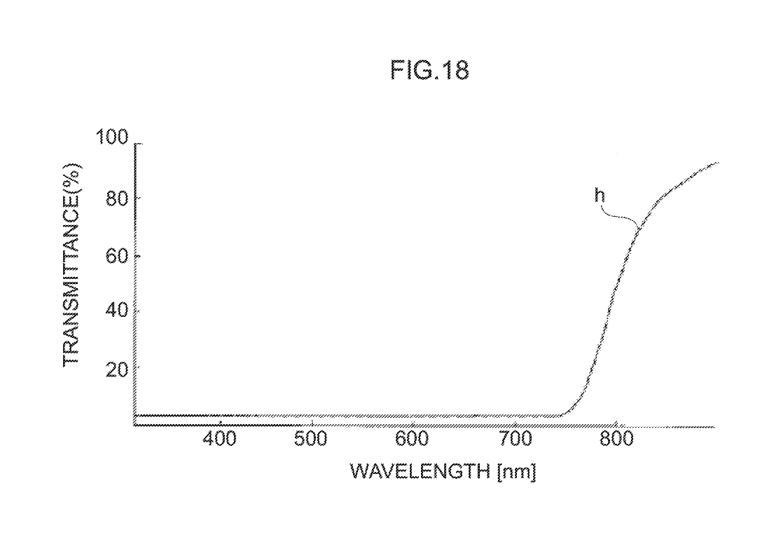

Further, the reflectance of light converted by the scintillator 71 and the transmittance of light for light calibration can be increased by employing a cold mirror as the half-mirror 104, i.e., by configuring the half-mirror 104 as a multi layer dielectric. The cold mirror has functions to reflect light of visible light wavelength region and transmit light of infrared wavelength region, as shown in FIG. 18. Although FIG. 18 indicates the transmittance, the reflectance can be obtained by calculating the reflectance=100%−the transmittance. In a case in which a cold mirror of a multi reflecting film having a structure such that a multilayer of Ge, MgF₂, ZnS, MgF₂, ZnS is formed on the glass substrate, as seen in FIG. 8 of Japanese Patent Application Laid-Open No. 8-292320, infrared light having a wavelength of greater than or equal to substantially 750 nm is transmitted through the cold mirror and the light having a wavelength of less than substantially 750 nm is reflected by the cold mirror.

Here, when the radiation detector 60 is an obverse reading type within the electronic cassette 10 as shown in FIG. 5, at the radiation detector 60, the radiation that is transmitted through the TFT substrate 66 is incident on the scintillator 71. When a substrate that is light-transmissive is used as the insulating substrate 64 that structures the TFT substrate 66, and the light-emitting section 122 for light calibration is disposed at the TFT substrate 66 side surface, the light-emitting section 122 deteriorates due to radiation. Further, when the light-emitting section 122 is made to be organic EL elements, unintended light emission arises at the light-emitting section 122 due to radiation, which is not preferable. Therefore, when the radiation detector 60 is made to be an obverse reading type, the light-emitting section 122 for light calibration is disposed at the scintillator 71 side surface, and the light from the light-emitting section 122 is transmitted through the scintillator 71 and illuminated onto the sensor portions 72 of the respective pixels 74.

Further, although columnar crystals of CsI transmit light, the light is gradually damped at the columnar crystal region. Therefore, the light amount must be made to be large in order to transmit light through the columnar crystal region and to illuminate light for light calibration onto the sensor portions 72 of the respective pixels 74. Thus, light calibration of the sensor portions 72 of the respective pixels 74 can be carried out by light that is generated at the scintillator 71, by causing the scintillator 71 to emit light by irradiating ultraviolet rays for example as the light for light calibration from the light guide plate 61 and the light source 95 or the light-emitting section 122.

The sensitivity of CsI varies due to changes in temperature, and, for example, the sensitivity decreases by around 0.3% due to a rise in temperature of one degree. Further, as imaging is carried out continuously and the cumulative amount of exposure increases, the sensitivity of CsI decreases, and the decreased sensitivity is restored when the CsI is maintained in a state in which radiation is not irradiated. Therefore, it is difficult to accurately measure the sensitivity of CsI. Thus, in cases in which large fluctuations in CsI are anticipated (e.g., a case in which imaging is switched from still imaging to video imaging, or a case in which the cumulative irradiated amount differs depending on the day, or a case in which the electronic cassette 10 that has not been used for several days is used, or the like), or in cases in which the sensitivity of CsI must be accurately known (e.g., a case in which capturing of a low-contrast image is carried out at a low amount of radiation in order to carry out energy subtraction processing, or a case in which changes in sensitivity must be known for accurate comparison with past images, or the like), the sensitivity of the CsI can be known from the accumulated charge amounts by illuminating a given amount of ultraviolet light from the light guide plate 61 and the light source 95 or the light-emitting section 122 and causing the scintillator 71 to emit light, and reading-out the charges accumulated in the respective pixels 74 of the radiation detector 60.

Although the above respective exemplary embodiments describe cases in which the present invention is applied to the radiographic imaging device that captures radiographic images by detecting X-rays as radiation, the present invention is not limited to the same. The radiation that is the object of detection may be, other than X-rays, any of gamma rays, a particle beam, or the like for example.

In addition, the structures that are described in the above exemplary embodiments are examples, and unnecessary portions may be deleted therefrom, new portions may be added thereto, and the states of connection and the like may be changed within a scope that does not deviate from the gist of the present invention.

What is claimed is:

1. A radiographic imaging device comprising:
a converting layer that is flat-plate-shaped and that converts irradiated radiation into light;
a light detecting substrate that is disposed at one surface side of the converting layer, and detects light converted by the converting layer;
an illuminating section that illuminates light with respect to another surface side of the converting layer; and
a half-mirror that is provided over an entire surface of a region, which is between the converting layer and the light illuminating section and which corresponds to a detection region at which light is detected by the light detecting substrate, the half-mirror reflecting at least a portion of light converted by the converting layer, and transmitting at least a portion of light illuminated by the light illuminating section.

2. The radiographic imaging device of claim 1, wherein
the converting layer is formed by a non columnar-crystal region and a columnar crystal region, that is continuous with the non columnar-crystal region, being layered, and the converting layer is provided such that the columnar crystal region faces the light detecting substrate.

3. The radiographic imaging device of claim 1, wherein
the light detecting substrate is attached to a surface, at an opposite side of a surface on which radiation that has been transmitted through an object of imaging is incident, of a top plate portion of a housing at which the top plate portion is provided an image-capturing surface on which the radiation is irradiated.

4. The radiographic imaging device of claim 1, wherein
light that is converted by the converting layer and light that is illuminated from the light illuminating section have different wavelength regions, and
a film thickness of the half-mirror is set such that reflectance of light of a second wavelength region that is converted by the converting layer, is higher than transmittance of light of a first wavelength region that is illuminated from the light illuminating section.

5. The radiographic imaging device of claim 1, wherein
an air layer is provided between the converting layer and the illuminating section.

6. The radiographic imaging device of claim 1, wherein the illuminating section comprises:
a light source; and
a light guide plate that is disposed so as to face the other surface side of the converting layer, and that guides light, that is generated at the light source, toward the light detecting substrate.

7. The radiographic imaging device of claim 6, wherein
the converting layer is formed on a light-transmissive substrate that is light-transmissive, and a structure comprising the converting layer and the light-transmissive substrate is affixed to the light detecting substrate such that the converting layer faces the light detecting substrate, and the light-transmissive substrate functions as the light guide plate.

8. The radiographic imaging device of claim 1, wherein
the illuminating section is a light-emitting panel that is disposed so as to face the other surface side of the converting layer and at which a light-emitting section is provided in correspondence with the converting layer.

9. The radiographic imaging device of claim 1, wherein
the half-mirror layer is formed to a size that is larger than an imaging region.

10. The radiographic imaging device of claim 1, wherein
the half-mirror layer is made of a metal.

11. The radiographic imaging device of claim 1, further comprising a protective layer that protects the half-mirror.

12. The radiographic imaging device of claim 11, wherein the protective layer is light-transmissive.

13. The radiographic imaging device of claim 11, wherein the protective layer is made of an organic film.

14. The radiographic imaging device of claim 12, wherein the protective layer is made of an organic film.

15. The radiographic imaging device of claim 1, wherein the illuminating section comprising a light-emitting panel at the converting layer side, the light-emitting panel comprising a light-emitting section.

16. The radiographic imaging device of claim 15, wherein the light-emitting section comprising an organic EL element.

17. The radiographic imaging device of claim 1, wherein the light detecting substrate comprising:
an upper electrode;
a lower electrode; and
a photoelectric converting film that is disposed between the upper and lower electrodes.

18. The radiographic imaging device of claim 3, wherein the light detecting substrate comprising:
an upper electrode;
a lower electrode; and
a photoelectric converting film that is disposed between the upper and lower electrodes.

19. The radiographic imaging device of claim 17, wherein the photoelectric converting film is made from an organic photoelectric converting material.

20. The radiographic imaging device of claim 18, wherein the photoelectric converting film is made from an organic photoelectric converting material.
